(19) United States
(12) Patent Application Publication
(10) Pub. No.: US 2023/0105178 A1
(43) Pub. Date: Apr. 6, 2023

(54) INFORMATION TERMINAL, MANAGEMENT SERVER, INFORMATION PROCESSING SYSTEM, AND DOWNLOAD OPERATION METHOD

(71) Applicant: Sony Interactive Entertainment Inc., Tokyo (JP)

(72) Inventors: Takehiko Tsurumi, Tokyo (JP); Makoto Sunayama, Tokyo (JP); Syunsuke Bamba, Tokyo (JP); Toru Yamamoto, San Mateo, CA (US); Makoto Oshita, Tokyo (JP); Koji Ihara, Tokyo (JP); Keisuke Ichikawa, Tokyo (JP); Yuki Ogawa, Tokyo (JP); Nobuyoshi Miyokawa, Tokyo (JP); Daisuke Matsunaga, Tokyo (JP)

(73) Assignee: Sony Interactive Entertainment Inc., Tokyo (JP)

(21) Appl. No.: 17/794,639

(22) PCT Filed: Jan. 22, 2021
(86) PCT No.: PCT/JP2021/002256

§ 371 Date: Jul. 22, 2022

(30) Foreign Application Priority Data
Jan. 29, 2020 (JP) 2020-012236

(51) Int. Cl. A63F 13/77; H04L 67/06

(52) U.S. Cl. CPC A63F 13/77; H04L 67/06

(57) ABSTRACT

In a case where the storage area of an information processing apparatus is insufficient for data to be downloaded, an information terminal causes the size of a lacking storage space and a list of stored data in the storage area to be displayed, and accepts, from a user, selection of the data targeted for deletion. If the selection is expected to resolve the lack of storage space, the information terminal accepts a deletion request and issues the deletion request to a management server to achieve deletion of the target data.

### TECHNICAL FIELD

The present invention relates to information processing technology that uses data provided via networks.

### BACKGROUND ART

Advances in information processing technology and expansion of networks in recent years have made it possible to obtain, via networks, diverse kinds of electronic content such as games, videos, and books and easily enjoy such content regardless of the scale of an apparatus in use or the time and place at which the content is accessed. Meanwhile, there has been an increasing availability of the kinds of content with their more complex and sophisticated processes executed in a limited environment, such as a head-mounted display that allows enjoyment of virtual reality reflecting the motion of a user.

### SUMMARY

### Technical Problems

There can be diverse times and places that evoke desires to enjoy even the content of which the execution environment is limited as mentioned above, such as while a user is on the go. Even if the execution environment is not restrictive, there may well be cases where some content, when viewed on a mobile terminal, evokes interest and is desired to be enjoyed at leisure on later occasions using a high-performing apparatus. In such cases, the user is first required to obtain necessary data if the data has yet to be stored in an apparatus for executing the content. It can thus be stressful for the user not to be able to start executing the content at a planned time. Further, if there is a time lag between the time at which the content evokes interest and the time at which the necessary data is acquired, the desire to perform the content may decline or be forgotten outright. This can thus be a lost occasion to get to know new content.

The present invention has been made in view of the above circumstances. An object of the invention is therefore to provide technology for easily and efficiently acquiring the data of electronic content via networks.

### Solution to Problems

One embodiment of the present invention relates to an information terminal. The information terminal includes a storage area operation section configured to acquire, from a management server via a network, information regarding a state of a storage area in an external information processing apparatus and cause the acquired information to be displayed, and an input information acquisition section configured to accept a user operation to change the state of the storage area on the basis of the displayed information. The storage area operation section transmits contents of the user operation to the management server to achieve a state change of the storage area according to the user operation.

Another embodiment of the present invention relates to a management server. The management server includes a state management section configured to connect with an information processing apparatus via a network and collect information regarding a state of a storage area in the information processing apparatus, and a storage area operation section configured to transmit, via the network, the information regarding the state to an information terminal different from the information processing apparatus and cause the information to be displayed, acquire contents of a user operation performed on the information terminal to change the state, and request the information processing apparatus for a process corresponding to the contents of the user operation, to achieve a state change of the storage area.

Still another embodiment of the present invention relates to an information processing system. The information processing system includes an information processing apparatus configured to perform information processing using data stored in a storage area thereof, a management server configured to connect with the information processing apparatus via a network to acquire information regarding a state of the storage area and transmit the acquired information via the network to an information terminal different from the information processing apparatus, and an information terminal configured to display the information regarding the state of the storage area, accept a user operation to change the state of the storage area on the basis of the displayed information, and transmit contents of the user operation to the management server, to achieve a state change of the storage area according to the user operation.

Yet another embodiment of the present invention relates to a download operation method. The download operation method includes a step of acquiring, from a management server via a network, information regarding a state of a storage area in an external information processing apparatus and causing the acquired information to be displayed, a step of accepting a user operation to change the state of the storage area on the basis of the displayed information, and a step of transmitting contents of the user operation to the management server to achieve a state change of the storage area according to the user operation.

Incidentally, if any other combinations of the above-described constituent elements or the above expressions of the present invention are converted between different forms such as a method, an apparatus, a system, and a computer program, they still constitute effective embodiments of this invention.

### Advantageous Effect of Invention

According to the present invention, the data of electronic content can be obtained easily and efficiently.

### BRIEF DESCRIPTION OF DRAWINGS

FIG. 1 is a diagram depicting an exemplary configuration of an information processing system according to the present embodiment.

FIG. 2 is a diagram depicting an internal circuit configuration of an information terminal according to the present embodiment.

FIG. 3 is a diagram depicting functional block configurations of an information terminal, a management server, and a content processing apparatus according to the present embodiment.

FIG. 4 is a diagram outlining a processing procedure for executing a download to the content processing apparatus by using the information terminal in the present embodiment.

FIG. 5 is a diagram depicting a procedure for handling a lack-of-space error that has occurred at a download destination when a download is requested in S12 in FIG. 4.

FIG. 6 is a diagram depicting an exemplary flow of transmission of information in the information processing system, the transmission being performed as an initial procedure for a download request process in the present embodiment.

FIG. 7 is a diagram depicting an exemplary flow of transmission of information from the issue of a download request to the start of a download in the present embodiment.

FIG. 8 is a diagram depicting an exemplary flow of transmission of information in a progress display process in the present embodiment.

FIG. 9 is a diagram depicting an exemplary flow of transmission of information in a lack-of-space error resolving process in the present embodiment.

FIG. 10 is a diagram depicting an exemplary flow of transmission of information upon successful download in the present embodiment.

FIG. 11 is a flowchart depicting a processing procedure for presentation of information regarding download operations by the information terminal in the present embodiment.

FIG. 12 is a flowchart depicting an error-handling procedure performed by the information terminal in S136 in FIG. 11.

FIG. 13 depicts diagrams depicting exemplary configurations of screens displayed for download operations on the information terminal in the present embodiment.

FIG. 14 depicts diagrams depicting exemplary configurations of screens displayed on the information terminal in a case where a lack-of-space error has occurred during download in the present embodiment.

FIG. 15 depicts diagrams depicting exemplary configurations of screens displayed on the information terminal in a case where a lack-of-space error has occurred during download in the present embodiment.

FIG. 16 depicts diagrams depicting other exemplary configurations of screens displayed on the information terminal in a case where a lack-of-space error has occurred during download in the present embodiment.

### DESCRIPTION OF EMBODIMENT

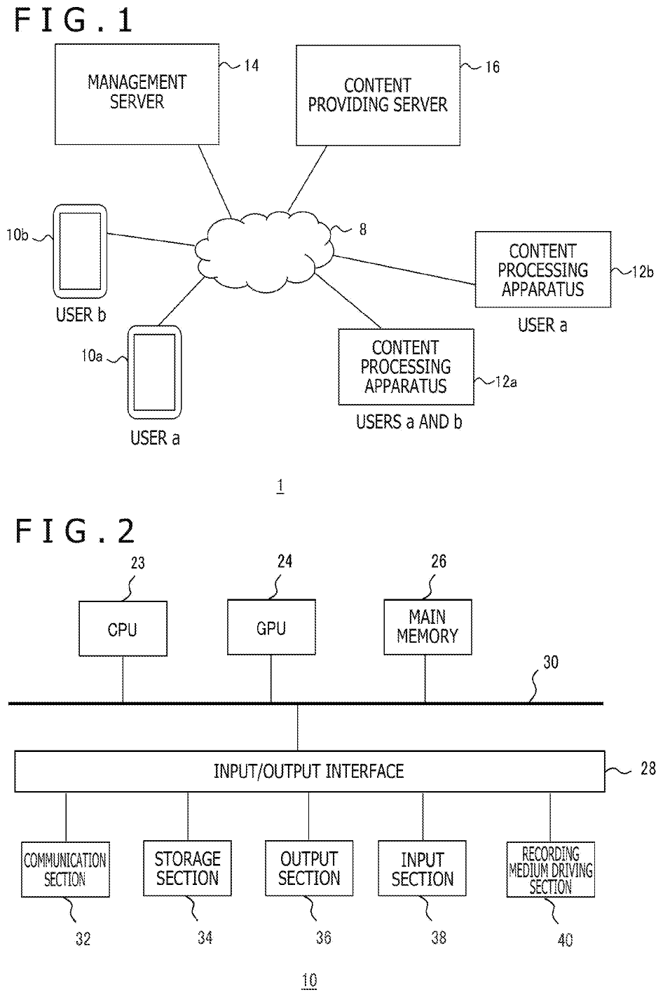

FIG. 1 depicts an exemplary configuration of an information processing system to which the present embodiment is applicable. An information processing system 1 has content processing apparatuses 12a and 12b, information terminals 10a and 10b, a content providing server 16, and a management server 14 interconnected via a network 8 such as the Internet. The content processing apparatus 12a and 12b that process electronic content such as games and videos may be any of such information processing apparatuses as game consoles, personal computers, and content reproduction apparatuses.

As with the apparatuses configured generally as described above, the content processing apparatuses 12a and 12b are each connected with an unillustrated input/output apparatus such as a controller, a camera, a display or a speaker, and output images and sounds of content therethrough in response to user operations. The content providing server 16 belongs, for example, to a company that markets software products such as games. The content providing server 16 transmits the data selected by the user to the content processing apparatus 12a or 12b via the network 8. The data transmitted here is not limited to anything specific as long as it is electronic data constituting application programs for executing diverse information processing such as games, or data representing images, documents, sounds, and settings, for example. In the description that follows, such electronic data will generically be referred to as “data.”

The procedures for accounting, authentication, and communication involved in downloading the data can use well-known techniques. The present embodiment, meanwhile, allows each user to select the target for download and to request execution of the download from an apparatus other than the content processing apparatus 12a or 12b serving as a download destination. In FIG. 1, the information terminals 10a and 10b such as high-performing mobile phones, tablet terminals, or mobile terminals are depicted as terminals that play the role of a download operation interface.

For example, in a case where the content processing apparatus 12a is used as a game console at home, the user can use the information terminal 10a to select a desired game and readily request downloading thereof to the content processing apparatus 12a in an in-between time while on the go or the like. This enables the user to enjoy the selected game as soon as the user comes home. When a highly portable terminal is used in this manner as a download operation interface, the degree of freedom in terms of operation with respect to place and time is increased. It is to be noted, however, that the apparatus serving as the interface is not limited to mobile information terminals. The apparatus playing the role of the interface may alternatively be one that is not usually considered portable, such as a game console, a personal computer, or a content reproduction apparatus.

For example, the content processing apparatus 12a may be used to perform operations to download to the content processing apparatus 12b. Here, the distance between the apparatus used for download operations and the apparatus serving as the download destination, the timing for the download operations, or the like is not limited to any specific settings. Described below is a mode in which download operations are performed by use of the information terminal 10a or 10b. In response to a download request from the information terminal 10a or 10b, the management server 14 controls execution of a download from the content providing server 16 to the content processing apparatus 12a or 12b.

The management server 14 further acquires information regarding the progress status of the download and an error that may occur during download, and transmits the acquired information to the information terminals 10a and 10b. Upon receipt of the information, the information terminal 10a or 10b presents its user with the download progress status, the contents of the error that has occurred, countermeasures for handling the error, and the like. For example, if the size of the download target data is found larger than the free space in a storage device of the content processing apparatus 12a as the download destination upon comparison, the information terminal 10a recognizes a lack-of-space error and displays information regarding the error.

In the case of the lack-of-space error, the management server 14 intervenes to let the information terminal 10a or 10b delete some already-stored data from the storage device of the content processing apparatus 12a or 12b. In this manner, the user can use the information terminal 10a or 10b to increase the free space of the storage device at the download destination, thereby resolving the lack-of-space error.

The present embodiment, in this manner, enables the user at an apparatus other than the download destination apparatus to verify an error occurring during download and take countermeasures to handle the error in addition to performing the download operations. This makes it possible to complete the download as much as possible beforehand, so that the content can be enjoyed as desired at a later time.

In the information processing system 1, the information terminals 10a and 10b, the content processing apparatuses 12a and 12b, the management server 14, and the content providing server 16 are not limited in number and configuration to those depicted. In the description that follows, the information terminals 10a and 10b may be generically referred to as the information terminal 10 and the content processing apparatuses 12a and 12b as the content processing apparatus 12. The relation between the information terminal 10 for performing download operations and the content processing apparatus 12 as the download destination is to be registered beforehand by the user. Alternatively, the content processing apparatus 12 serving as the download destination may be selected by use of the information terminal 10.

In many cases, a unique user is associated with the information terminal 10. In the illustrated example, a user “a” is set for the information terminal 10a and a user “b” for the information terminal 10b. On the other hand, in the case of a game console, for example, multiple users may be registered for the content processing apparatus 12. In the illustrated example, the users “a” and “b” are registered for the content processing apparatus 12a, while the user “a” alone is registered for the content processing apparatus 12b.

For example, the management server 14 performs control to have the data downloaded to the selected one of the content processing apparatuses 12 for which is registered the same user as that for the information terminal 10 having requested the download. Preferably, even if other users are registered for the content processing apparatus 12 serving as the download destination, solely the information terminal 10 of the user having requested the download is to be the terminal that displays the information regarding the download progress status and error-related information. This enables the user having performed the download operations to verify the download progress status and handle the error in a unified manner.

Even in a case in which, after being used to request a download, the information terminal 10 is used for other uses or returned to the home screen, the management server 14 arranges to give a push notification of the download error to the information terminal 10. This enables the user to know the error that may occur during the user-requested download process, offering the user a higher possibility of taking suitable countermeasures. In a case where one user owns multiple information terminals 10, the management server 14 may preferably notify all of them of relevant information, thereby ensuring unfailing notification of the error information.

FIG. 2 depicts an internal circuit configuration of the information terminal 10. The information terminal 10 includes a CPU (Central Processing Unit) 23, a GPU (Graphics Processing Unit) 24, and a main memory 26. These components are interconnected via a bus 30. The bus 30 is further connected with an input/output interface 28. The input/output interface 28 is connected with a communication section 32 constituted by peripheral device interfaces such as a USB (Universal Serial Bus) and IEEE (Institute of Electrical and Electronic Engineers) 1394 and by a wired or wireless LAN (Local Area Network) network interface, a storage section 34 such as a hard disk drive or a nonvolatile memory, an output section 36 that outputs data to a display unit, not depicted, an input section 38 that receives input of data from an input device, not depicted, and a recording medium driving section 40 that drives a removable recording medium such as a magnetic disk, an optical disk, or a semiconductor memory.

The CPU 23 controls the entire information terminal 10 by executing an operating system stored in the storage section 34. Also, the CPU 23 performs various programs retrieved from the removable recording medium and loaded into the main memory 26 or downloaded via the communication section 32. Further, the communication section 32 establishes communication with an external apparatus such as the management server 14 and acquires therefrom diverse data necessary for internal processing or transmits the contents of user operations thereto.

The GPU 24 has the functions of a geometry engine and a rendering processor. According to a rendering instruction from the CPU 23, the GPU 24 performs a rendering process and stores a display image resulting therefrom into a frame buffer, not depicted. The GPU 24 further converts the display image stored in the frame buffer to a video signal for output to the output section 36. The main memory 26 includes a RAM (Random Access Memory) and stores programs and data necessary for processing. It is to be noted that the content processing apparatus 12, the management server 14, and the content providing server 16 may have a similar internal circuit configuration each.

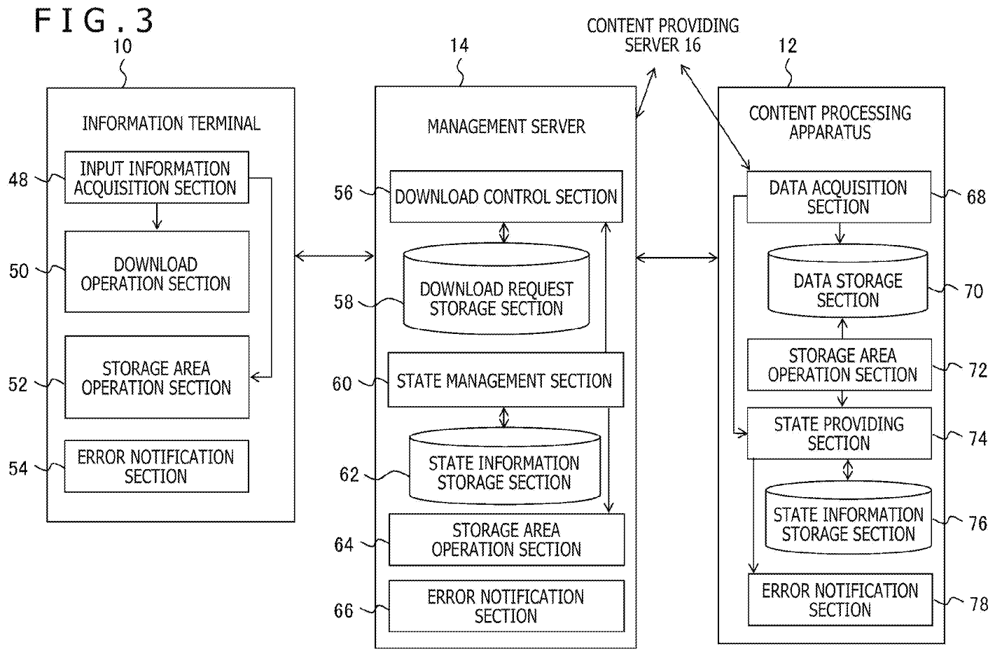

FIG. 3 depicts functional block configurations of the information terminal 10, the management server 14, and the content processing apparatus 12. The elements depicted in the drawing as the functional blocks for performing various processes can be configured by hardware using the CPU, the GPU, and the main memory as described above, and is implemented by software using programs stored on a recording medium or in a storage device and loaded into the memory. It will be understood by those skilled in the art that these functional blocks can be implemented by hardware alone, by software alone, or by a combination of both in diverse forms and that the implementation is not limited to a particular form.

FIG. 3 also depicts only the functional blocks related to the present embodiment and omits the functions possessed inherently by the information terminal 10 and by the content processing apparatus 12 for carrying out other information processing. The information terminal 10 includes an input information acquisition section 48 that acquires the contents of user operations, a download operation section 50 that controls download-related operations, a storage area operation section 52 that controls operations related to the storage area in the content processing apparatus 12, and an error notification section 54 that gives notification of error information to the user.

The input information acquisition section 48 acquires the contents of user operations on the information terminal 10. For example, in response to the user's touch operation on a touch panel covering the display unit of the information terminal 10, the input information acquisition section 48 identifies the contents of the operation on the basis of a GUI (Graphical User Interface) displayed on the display unit. It is to be noted, however, that there may be diverse means for performing user operations and that the input information acquisition section 48 may acquire the contents of user operations by using procedures corresponding to the means in use.

The download operation section 50 causes the display unit to display information regarding the download of data to the content processing apparatus 12 such that the user can request execution of the download and verify diverse information. For example, the download operation section 50 presents the user with the following information.
1. List of data candidates for download
2. List of candidates of the content processing apparatus 12 as the download destination
3. Download progress status
4. Details of the error having occurred
5. GUI for selecting from the list, for starting the download, and for handing the error

The storage area operation section 52 causes the display unit to display information regarding the storage area in the content processing apparatus 12 established as the download destination such that the user may resolve a lack-of-space error that may occur. For example, the storage area operation section 52 presents the user with the following information.
1. Storage space insufficient for download
2. List of data candidates for deletion from the storage area
3. GUI for selecting from the list and for starting the deletion

In order to present the above-listed information, the download operation section 50 and the storage area operation section 52 acquire necessary information from the management server 14. These components then obtain the contents of user operations on the displayed GUI and transmit the acquired contents to the management server 14. In a case where a download-related error has occurred, the error notification section 54 causes the display unit to display notification to that effect. For example, the notification may be implemented in the form of a push notification from the content processing apparatus 12 via the management server 14.

In a case where a lack-of-space error has occurred, the storage area operation section 52 may be activated by user operations on the GUI displayed by the download operation section 50 or by the error notification section 54 for storage area operations. Further, the storage area operation section 52 may terminate its function at the time at which the user has deleted data and resolved the lack-of-space error.

The management server 14 includes a download control section 56 that controls a download requested from the information terminal 10, a download request storage section 58 that temporarily stores a download request, a state management section 60 that manages the latest state of the content processing apparatus 12, a state information storage section 62 that stores the latest state information regarding the content processing apparatus 12, a storage area operation section 64 that controls storage area operations on the content processing apparatus 12, and an error notification section 66 that transmits error information to the information terminal 10 for the sake of the user.

In response to user operations on the information terminal 10, the download control section 56 controls the download of data from the content providing server 16 to the content processing apparatus 12. That is, the download control section 56 issues, to the content processing apparatus 12, a request causing the download target data selected by the user at the information terminal 10 to be transmitted from the content providing server 16 to the content processing apparatus 12 established as the download destination.

In a preliminary step before issuing the request, the download control section 56 may transmit, to the information terminal 10, a list of candidate data for download, in response to the user operations on the information terminal 10. This list is created on the basis of user-selected categories and a history of previous selection from a database, not depicted. The download control section 56 then acquires, from the information terminal 10, a request to download the data selected from the list. The download control section 56 causes the download request storage section 58 to temporarily queue the acquired request in association with identification information identifying the content processing apparatus 12 which is the download destination.

Thereafter, in response to a query from the content processing apparatus 12, the download control section 56 gives notification of the download request associated with the query, thereby causing the content processing apparatus 12 to execute the download. Details of the procedure for data download can be derived from the currently practiced procedures and thus will not be discussed further.

The state management section 60 acquires the information regarding the latest state of the content processing apparatus 12 and supplies the acquired information as needed to the information terminal 10. For example, the state management section 60 obtains the following information from the content processing apparatus 12.
1. Registered users
2. Whether or not the apparatus is registered as the preferred download destination
3. Information regarding the data already stored in the storage area
4. Free space of the storage area
5. Download progress status
6. Status of use

For example, the state management section 60 acquires the latest information regarding the above items 1 through 3 in regular sessions with the content processing apparatus 12, and stores the acquired latest information into the state information storage section 62 in association with identification information identifying this content processing apparatus 12. With respect to the above items 4 through 6, the state management section 60 obtains the latest information from the content processing apparatus 12 at the time at which a download request is issued, for example. Also, at the time at which the download control section 56 identifies the content processing apparatus 12 as the download destination or determines whether or not a download is available, the state management section 60 provides the download control section 56 with the latest state information regarding the content processing apparatus 12.

Further, at the time at which the user operates on the stored data in response to a lack-of-space error, the state management section 60 provides the storage area operation section 64 with the latest information regarding the stored data. In response to user operations on the information terminal 10, the storage area operation section 64 requests the content processing apparatus 12 to delete some stored data from its storage area. This process is basically carried out to resolve the lack-of-space error that may occur during download. The storage area operation section 64 thus issues a deletion request to the content processing apparatus 12 serving as the download destination.

In a case where multiple storage devices are connected to the content processing apparatus 12 serving as the download destination, the information terminal 10 may be given a choice to select one of the connected storage devices as the download destination. In this case, the storage area operation section 64 transmits, to the information terminal 10, the latest list of data stored in the selected storage device, and causes the information terminal 10 to display the candidate data to be deleted. The storage area operation section 64 then requests the content processing apparatus 12 to delete the data from the selected storage device. In a case where a download-related error occurs, the error notification section 66 acquires a notification to that effect from the content processing apparatus 12 and transmits the acquired notification to the information terminal 10.

The content processing apparatus 12 includes a data acquisition section 68 that downloads data, a data storage section 70 that stores downloaded data, a storage area operation section 72 that operates on the data stored in the data storage section 70, a state providing section 74 that provides the latest state information regarding the content processing apparatus 12, a state information storage section 76 that stores the state information, and an error notification section 78 that transmits error information to the management server 14.

The data acquisition section 68 downloads the data selected by the user from the content providing server 16. With the present embodiment, as discussed above, in response to user operations on the information terminal 10, the download is executed basically under control of the download control section 56 of the management server 14. Meanwhile, the data acquisition section 68 may be assigned the usual function of accepting the download request made by the user who directly operates the content processing apparatus 12 and of downloading the data accordingly.

The data acquisition section 68 stores the downloaded data into the data storage section 70. Also, the data acquisition section 68 notifies the state providing section 74 of the progress status of the process during the download period and of the latest data storage status in the data storage section 70 upon completion of the download. The data storage section 70 is a storage device built in, or attached externally to, the content processing apparatus 12. The free space of this storage device is compared with the size of the data requested to be downloaded. If the free space is insufficient, a lack-of-space error occurs and the stored data is targeted for deletion to resolve the error.

According to a request from the storage area operation section 64 in the management server 14, the storage area operation section 72 deletes the data selected by the user from the data storage section 70. The storage area operation section 72 notifies the state providing section 74 of the fact that the data is being deleted and what has resulted from the deletion. The state providing section 74 collects the latest state information regarding the content processing apparatus 12, stores the collected information into the state information storage section 76, and supplies the information to the management server 14 in a suitably timed manner. The state information storage section 76 stores state information similar to the above-mentioned state information in the state information storage section 62 of the management server 14. In a case where a download-related error occurs, the error notification section 78 requests the management server 14 to transmit a notification to that effect to the information terminal 10.

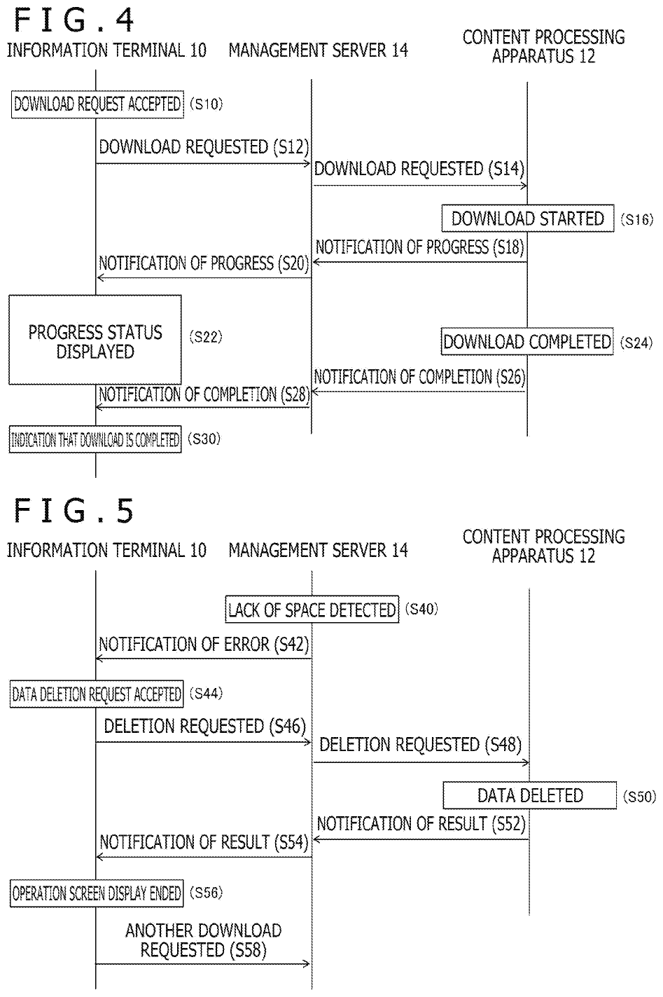

Explained below are the operations of the information processing system 1 that can be implemented by use of the above-described configuration. FIG. 4 outlines a processing procedure for executing a download to the content processing apparatus 12 by using the information terminal 10. First, the information terminal 10 displays a list of candidate data such as software and content making up the download candidates, and accepts selected data and a download execution request (S10). The information terminal 10 then transmits, to the management server 14, the request to download the selected data (S12). At this point, the information terminal 10 may include, in the request, identification information identifying the content processing apparatus 12 which is the download destination.

It is to be noted that, in a case where the “preferred apparatus as the download destination” is set as the download destination, the setting of the apparatus for the destination can be omitted by having its identification information shared within the system. The management server 14 queues the acquired download request for sequential request processing. That is, in response to a query from the content processing apparatus 12, the management server 14 returns the download request that sets the content processing apparatus 12 as the download destination (S14). The content processing apparatus 12 executes the returned request, thereby starting to download the selected data from the content providing server 16 (S16).

Although not depicted, at the time at which the download request is acquired from the information terminal 10 in S12, the management server 14 verifies whether there is any fault (error) that may hamper execution of the download. If there is an error, the management server 14 notifies the information terminal 10 thereof. The error includes a case where communication cannot be established with the content processing apparatus 12, in addition to the lack of storage space therein as discussed above.

In that case, the information terminal 10 displays the contents of the reported error, thereby prompting the user either to retry the download after taking suitable countermeasures or to cancel the download request. As one such countermeasure against the error, in a case where the storage area of the content processing apparatus 12 is insufficient, the information terminal 10 accepts, from the user, an operation to delete stored data. When there is no error, the download is started as depicted (S16). The content processing apparatus 12 thus transmits the progress status of the download to the information terminal 10 via the management server 14 (S18 and S20).

This allows the information terminal 10 to display the download progress status, i.e., how much of the whole data has been downloaded and how much longer it will take for the download to be completed (S22). However, obviously, this display can be omitted if the user closes the screen, for example. When the download is completed (S24), the content processing apparatus 12 then notifies the information terminal 10 of the completion via the management server 14 (S26 and S28). In turn, the information terminal 10 gives an indication that the download is completed (S30).

With regard to completion of the download, a push notification may be made to the user such that the user will know the completion even if the screen for download operations is closed. In a case where an error occurs during download, the occurrence of the error may be displayed on the download operation screen, or a push notification indicative of the error may be carried out. In this case, the content processing apparatus 12 may be caused to transmit the contents of the error such that the user will know it on the information terminal 10.

Notifications indicating the start and completion of download as well as the occurrence of error may also be displayed likewise on the display unit of the content processing apparatus 12. This enables another user who may be using the content processing apparatus 12 to know that download operations have been carried out externally. In some cases, the error that has occurred can be handled on the side of the content processing apparatus 12.

FIG. 5 depicts the procedure for handling a lack-of-space error that has occurred at the download destination when the download is requested in S12 in FIG. 4. In this case, the steps from S14 onward in FIG. 4 are placed in a standby state until the error is resolved. When the management server 14 detects an insufficient storage space upon comparison between the size of the data targeted for download and the free space in the data storage section 70 (S40), the management server 14 transmits a notification of the error to the information terminal 10 (S42). The information terminal 10 displays the notification and, in response to operations by the user viewing the display, displays a screen for storage area operations to accept a data deletion request (S44).

At this point, the information terminal 10 indicates both the size of each of the data items stored in the data storage section 70 of the content processing apparatus 12 and the insufficient storage space, thereby allowing the user to easily select a minimum deletion target. When the deletion target data with its size larger than the insufficient storage space is selected, the information terminal 10 accepts a request to delete the data and transmits the deletion request to the management server 14 (S46). The management server 14 transmits the deletion request to the content processing apparatus 12 (S48), which causes the content processing apparatus 12 to delete the selected data from the data storage section 70 (S50).

When deletion of the data is completed, the content processing apparatus 12 notifies the information terminal 10 to that effect via the management server 14 (S52 and S54). In turn, the information terminal 10 terminates the display of the screen for storage area operations by displaying an indication that the deletion is completed (S56). The information terminal 10 then makes another download request by notifying the management server 14 of the fact that the error has been resolved (S58). In practice, this request may be made by changing the step of S14 in FIG. 4 from the standby state to an execution state. With the lack-of-space error resolved by deletion of data, the download process is automatically resumed.

It is to be noted that, in a case where the management server 14 cannot establish connection with the content processing apparatus 12 or where another user is using the data targeted for deletion on the content processing apparatus 12, either the management server 14 or the content processing apparatus 12 may determine that an error has occurred and interrupt the deletion process accordingly. In this case, as in the case of download-related errors, the information terminal 10 is caused to display, for verification by the user, an indication that the error has occurred and the contents of the error.

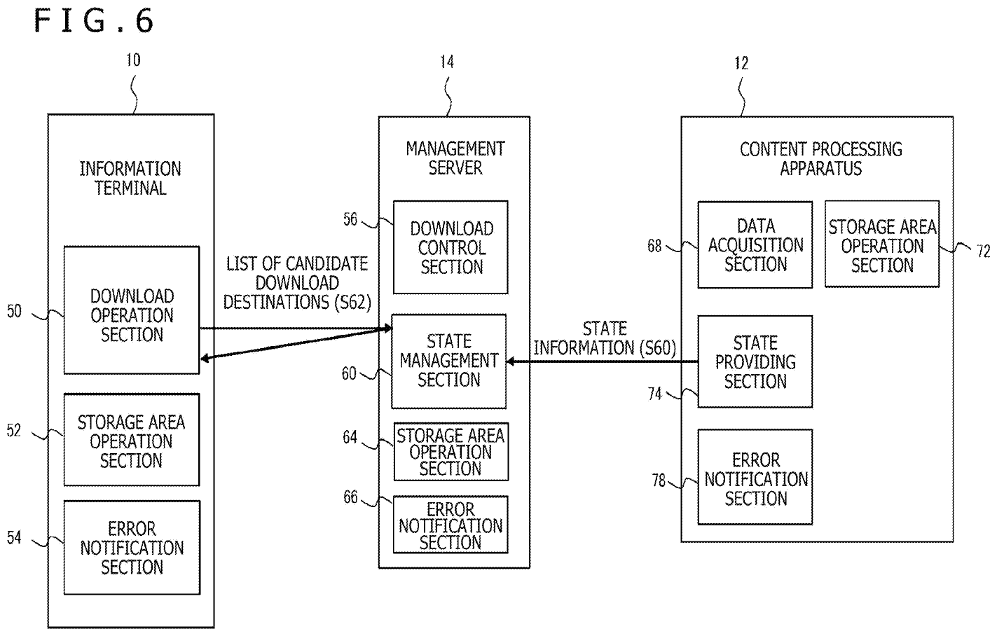

FIG. 6 depicts an exemplary flow of the transmission of information in the information processing system 1 as an initial procedure for the download request process depicted in FIG. 4. The state providing section 74 in the content processing apparatus 12 accesses the management server 14 at predetermined time intervals to transmit thereto the latest information regarding the above-described various states (S60). The download operation section 50 in the information terminal 10 queries the management server 14 at a predetermined timing for a list of the content processing apparatuses 12 each of which can be designated as the download destination by the user of the information terminal 10 (S62).

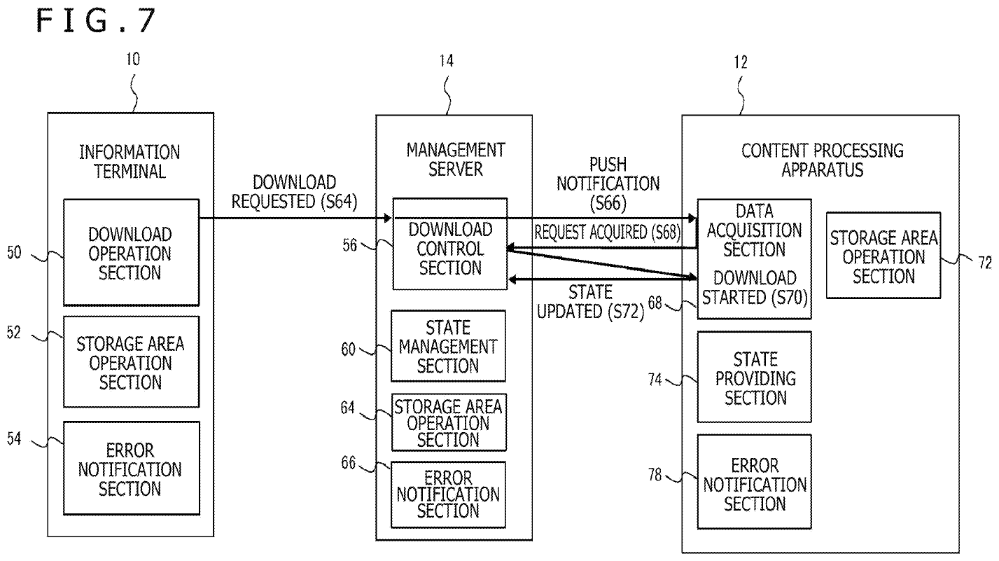

The list is created by the management server 14 on the basis of the users registered for the content processing apparatuses 12 and on the types of storage devices connected thereto. FIG. 7 depicts an exemplary flow of the transmission of information in the steps ranging from the issue of a download request to the start of a download as indicated by S10 through S16 in FIG. 4. First, the download operation section 50 in the information terminal 10 issues a download request to the management server 14 (S64). The request includes the download target data and the identification information identifying the content processing apparatus 12 which is the download destination.

The download control section 56 in the management server 14 gives the content processing apparatus 12 as the download destination a push notification indicating that a download is requested (S66). In turn, the data acquisition section 68 in the content processing apparatus 12 accesses the management server 14 at a suitable timing to acquire the download request stored temporarily in the download request storage section 58, and starts the download accordingly (S68 and S70). With the download started, the data acquisition section 68 requests the download control section 56 to update, to reflect the start of the download, the state of the request stored in the management server 14 (S72).

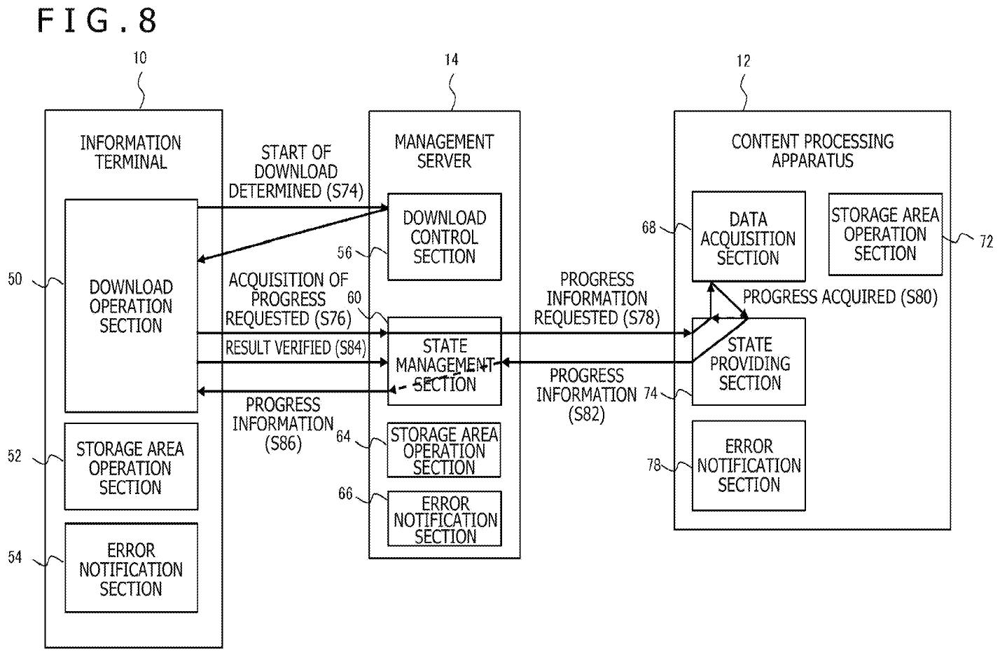

FIG. 8 depicts an exemplary flow of the transmission of information in a download progress display process carried out subsequent to the steps in FIG. 7. This process corresponds to the steps from S18 to S22 in FIG. 4. By querying the management server 14, the download operation section 50 in the information terminal 10 determines that the download which the download operation section 50 has requested has stated (S74). The download operation section 50 then requests the management server 14 to acquire information regarding the progress of the download (S76).

In response to the request, the state management section 60 in the management server 14 requests the content processing apparatus 12 for download progress information (S78). The state providing section 74 in the content processing apparatus 12 acquires the progress information by querying the data acquisition section 68, and returns the acquired information to the management server 14 (S80 and S82). According to a result verification request from the download operation section 50 in the information terminal 10, the state management section 60 in the management server 14 transmits the progress information transmitted from the content processing apparatus 12 (S84 and S86). This enables the information terminal 10 to display the download progress status.

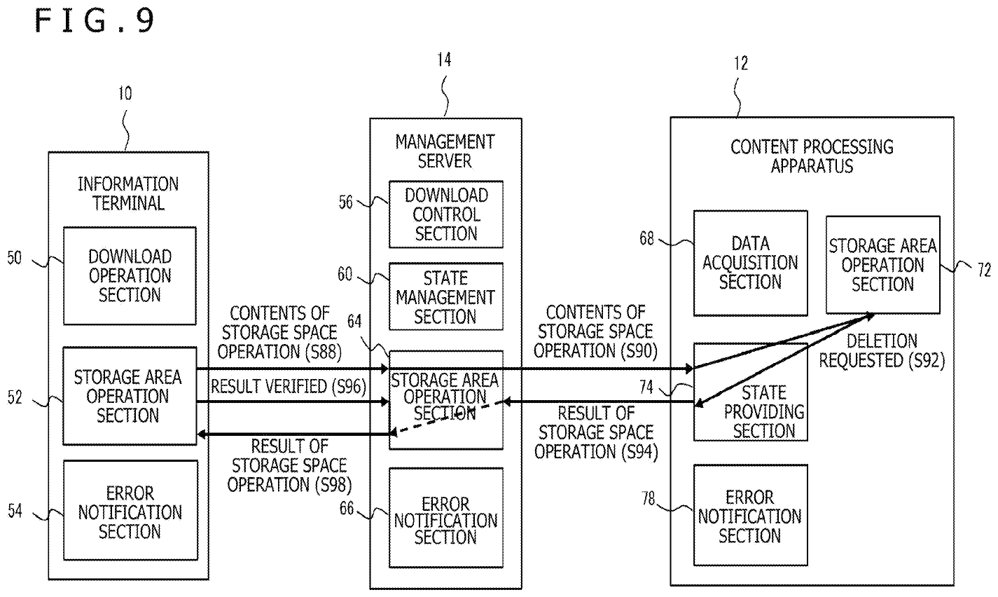

FIG. 9 depicts an exemplary flow of the transmission of information in the lack-of-space error resolving process from S44 to S54 in FIG. 5. Prior to the information transmission, the management server 14 notifies the information terminal 10 of a lack-of-space error. Upon viewing the notification, the user opens the screen for storage space operations. This enables the storage area operation section 52 to accept user operations on the screen. In order to accept user operations, the storage area operation section 52 acquires a list of the data currently stored in the data storage section 70 of the content processing apparatus 12 serving as the download destination, and issues a request to delete the data selected by the user from the list.

In FIG. 9, these operations are generically referred to as a “storage space operation.” When the storage area operation section 52 transmits the contents of the storage space operation to the management server 14 (S88), the storage area operation sect 64 in the management server 14 forwards the transmitted contents to the content processing apparatus 12 (S90). In a case where the latest list of stored data is requested, the state providing section 74 in the content processing apparatus 12 retrieve the relevant information from the state information storage section 76. In a case where deletion of data is requested, the state providing section 74 requests the storage area operation section 72 to delete the selected data. The storage area operation section 72 in turn deletes the selected data and returns the result of the deletion (S92).

The state providing section 74 transmits, to the management server 14, either the retrieved data list or the result of the data deletion process (S94). It is to be noted that, in the case where data is deleted, the state providing section 74 causes the state information in the state information storage section 76 to reflect the deletion of the data. In response to a result verification request from the storage area operation section 52 in the information terminal 10, the storage area operation section 64 in the management server 14 transmits either the list of the data stored in the data storage section 70 of the information terminal 10 or the result of the data deletion process (S96 and S98). This allows the user at the information terminal 10 to suitably select the data targeted for deletion from an accurate list of the stored data at the time at which the download request is made. The user can further verify in real time that the deletion is performed with no problem.

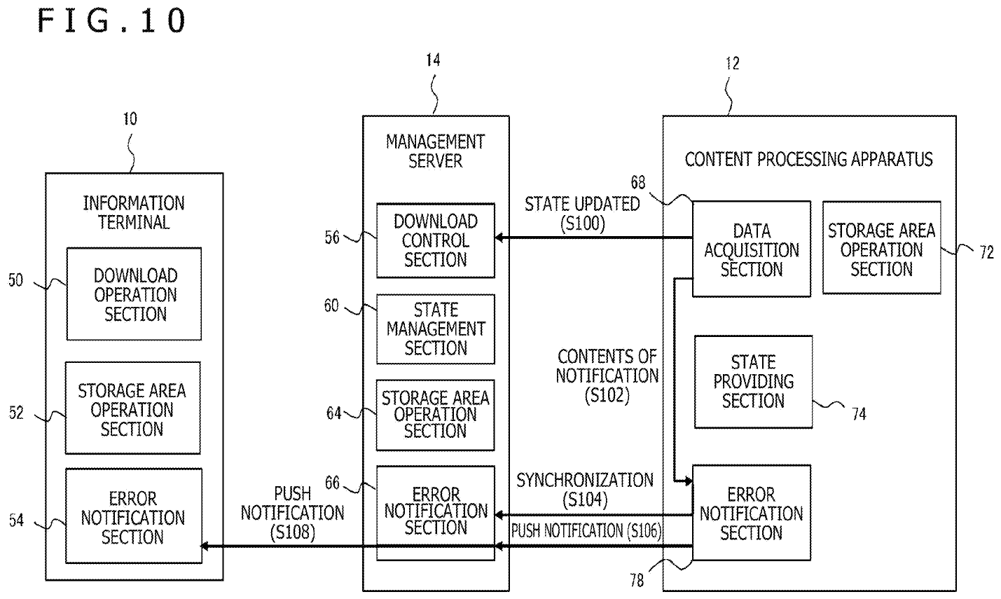

FIG. 10 depicts an exemplary flow of the transmission of information in S24 through S30 in FIG. 4, the transmission of information being performed when a download is successfully completed. Upon completion of the download, the data acquisition section 68 in the content processing apparatus 12 requests the download control section 56 to perform a state update such as deletion of the relevant request from the list of requests stored temporarily in the management server 14 (S100). Meanwhile, the data acquisition section 68 notifies the error notification section 78 of the contents of a notification indicative of the successful download (S102).

In synchronism with the processing of the error notification section 66 in the management server 14, the error notification section 78 requests the management server 14 to notify the information terminal 10 of the contents transferred from the data acquisition section 68 (S104 and S106). In response to the request, the error notification section 66 in the management server 14 gives a push notification to the information terminal 10 (S108). The transmission of information depicted in FIG. 10 similarly takes place even in a case where the download is unsuccessful. This allows the user to verify whether the download is successful or not in real time.

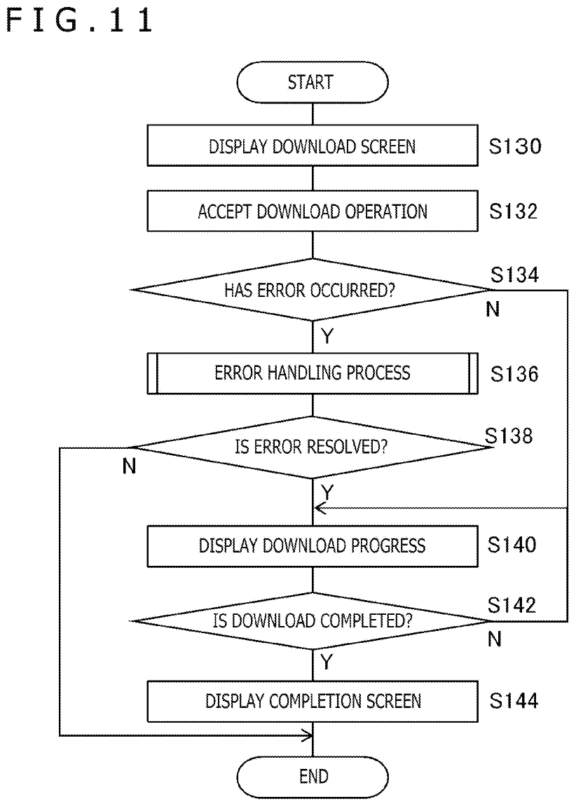

FIG. 11 is a flowchart depicting the processing procedure for presentation of information regarding download operations by the information terminal 10 in the present embodiment. The procedure in the flowchart is started when the user activates a download application on the information terminal 10 or causes the screen of a website for executing the download to be displayed on a browser. In turn, the download operation section 50 in the information terminal 10 causes the download operation screen to be displayed (S130). This screen includes information regarding the candidate data for download, i.e., information regarding details of the candidate content and software as well as GUIs for selecting data and for starting a download.

When the user viewing the screen selects the data and performs an operation to finalize the download, the download operation section 50 accepts the operation and transmits a request to download the data to the management server 14 (S132). In a case where a notification indicating that an error has occurred is received from the management server 14 in response to the request (Y in S134), the information terminal 10 carries out an error handling process including display of the error content (S136). If the error is not resolved, the information terminal 10 terminates the process in response to a cancellation operation by the user, for example (N in S138).

In a case where the error is resolved with the storage space becoming sufficient as a result of the deletion of data, for example (Y in S138), or where there has been no error from the beginning (N in S134), the content processing apparatus 12 starts the download. At this point, the download operation section 50 in the information terminal 10 acquires download progress status continuously from the management server 14 while allowing the status to be displayed (S140). The download operation section 50 continuously updates and displays the progress status until a notification indicating completion of the download is acquired (N in S142). Upon completion of the download, the download operation section 50 displays an indication to that effect and terminates the process (Y in S142 and S144).

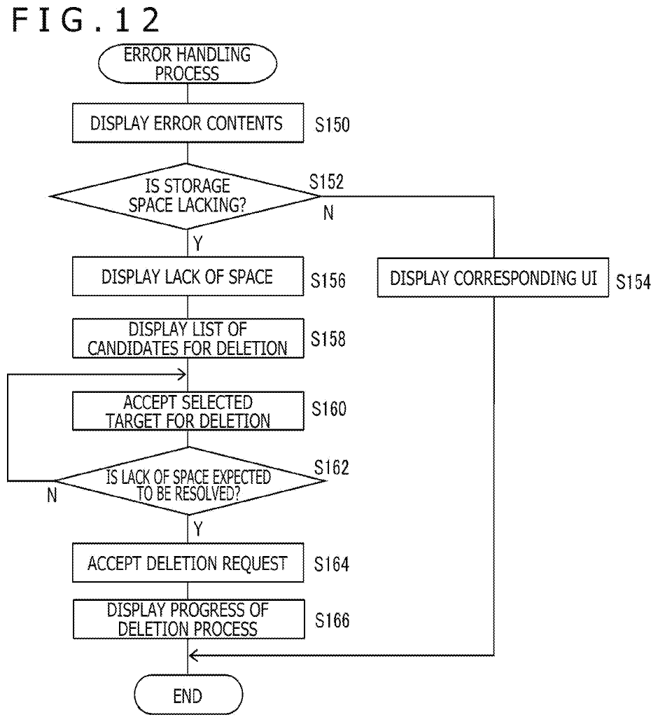

FIG. 12 is a flowchart depicting the error handling procedure performed by the information terminal 10 in S136 in FIG. 11. First, the download operation section 50 displays the error contents transmitted from the management server 14 (S150). Then, depending on the error contents, the download operation section 50 varies a UI (User Interface) to be prepared next. Whereas the illustrated example depicts the process as branching depending on whether the space of the storage area is sufficient or not, this is not limitative of how the present embodiment may be implemented.

In the illustrated example, in a case where the error contents are other than the lack of storage space (N in S152), the download operation section 50 displays a UI prompting the user to improve the state of the source of error occurrence, for example, and to select whether to retry the download or to cancel the request (S154). In a case where the error content is an insufficient storage space (Y in S152), the download operation section 50 first causes the lack of storage space to be displayed (S156). The storage area operation section 52 then displays a list of the candidate data for deletion and the size of each of the data candidates (S158), thereby accepting selection of the data to be deleted from the user (S160).

The screen for storage area operations presented by the storage area operation section 52 is displayed preferably by instructions from the user. The storage area operation section 52 calculates and displays the size of the free storage space still needed following deletion of the data selected by the user. The display allows the user to easily determine an approximate size of additional data to be targeted for deletion. The storage area operation section 52 accepts selection of the data to be deleted until the lack of storage space is resolved (N in S162 and S160). When the lack of storage space is expected to be resolved, the storage area operation section 52 causes a GUI for finalizing the deletion to be displayed, thereby accepting a deletion request (Y in S162 and S164).

The storage area operation section 52 then transmits the deletion request to the management server 14 and displays the progress of the deletion process such as deletion in progress and deletion completed (S166). In the case where the data deletion is completed or where the user takes countermeasures and performs a retry operation in S154, the download operation section 50 determines that the error is resolved in S138 in FIG. 11. In other cases, or in a case where an error still exists after the countermeasures have been taken, the download operation section 50 determines that the error is not resolved.

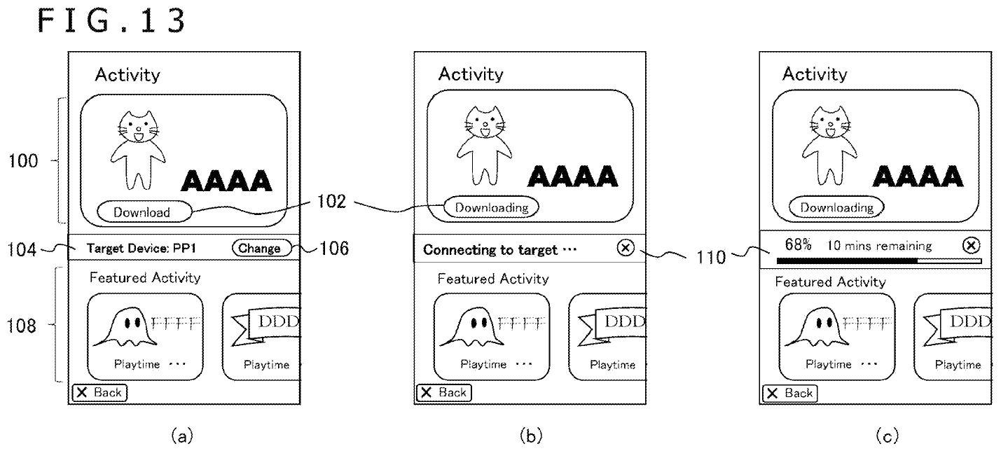

FIG. 13 depicts exemplary configurations of screens for download operations displayed on the information terminal 10. In the description that follows, a game application is assumed to be downloaded. Subfigure (a) depicts an initial state of the download operation screen displayed in S130 in FIG. 11. This screen includes a download candidate game display field 100, a download request GUI 102, a download destination content processing apparatus field 104, a download destination changing GUI 106, and an other-game display field 108.

The download candidate game display field 100 displays information regarding the banners and contents of the download candidate games previously selected by the user. The download candidates may be selected from the other-game display field 108 or from another screen. The download destination content processing apparatus field 104 displays the name of the content processing apparatus 12 currently set as the download destination. This content processing apparatus 12 may be the preferred apparatus set beforehand by the user as the download destination, or may be selected at the time at which the download request is made.

When the download destination changing GUI 106 is operated, the download operation section 50 displays, in a pop-up window, for example, a list of the content processing apparatuses 12 each of which can be designated as the download destination, and accepts operations to change apparatuses from the user. When the user operates the download request GUI 102, the download operation section 50 finalizes the game download request displayed in the download candidate game display field 100.

Subfigure (b) displays an exemplary screen displayed at that point. In this example, what is displayed in the download request GUI 102 is changed from “Download” to “Downloading,” which indicates that the download request is accepted. At this point, any operation on this GUI is invalid. Also, the download destination content processing apparatus field 104 depicted in Subfigure (a) is replaced with a state display field 110 giving text information such as “Connecting to target . . . ,” for example. This indicates that the content processing apparatus 12 is being accessed for download via the management server 14.

In a case where communication is established with the download destination content processing apparatus 12 and where no other error has occurred, the download is started as requested. Subfigure (c) depicts an exemplary screen that is indicative of the progress status of the download and that is displayed in S140 in FIG. 11. In this example, the state display field 110 indicates the download progress status. Specifically, a text and an indicator are combined to indicate that “68%” of the download target game application has been downloaded, with text information indicating that the remaining time until completion of the download is “10 mins” (10 minutes).

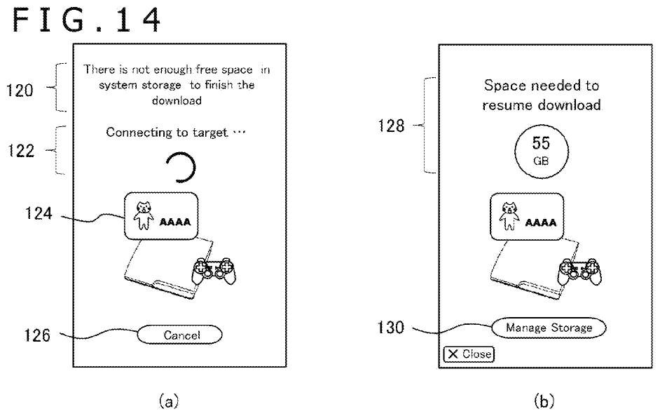

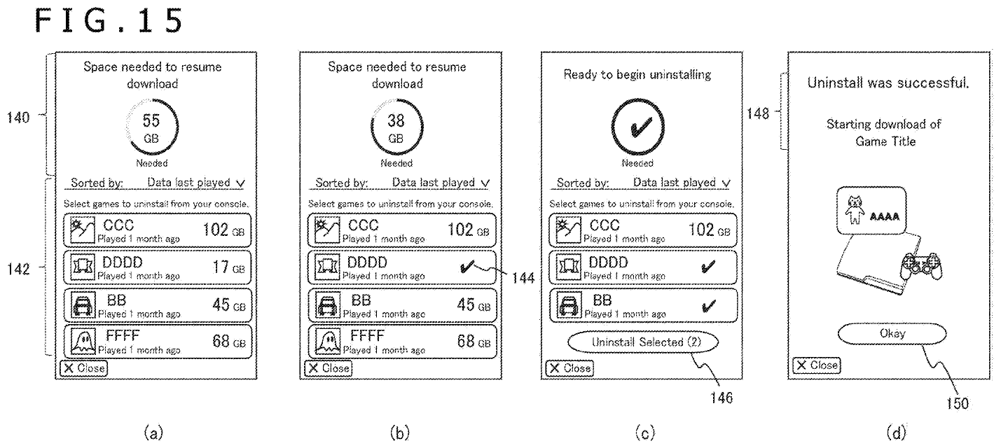

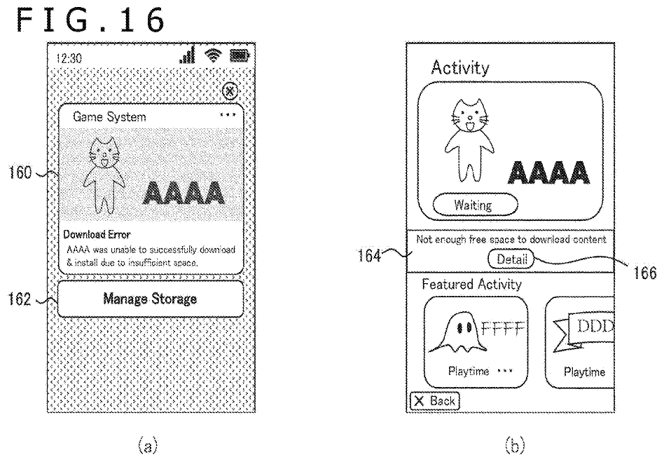

FIGS. 14 and 15 depict exemplary configurations of screens displayed in the information terminal 10 in the case where a lack-of-space error has occurred during download. Subfigure (a) in FIG. 14 depicts a screen that is indicative of the error contents and that is displayed in S150 in FIG. 12. This screen includes an error contents display field 120, a connection-underway display field 122, a download target game display field 124, and a request cancel GUI 126. The screen allows the user to know that a lack-of-space error has occurred and that the management server 14 is connecting to the content processing apparatus 12 as the download destination to determine precisely how much of storage space is lacking.

Here, in a case where the user operates the request cancel GUI 126, the download operation section 50 cancels the download request and returns the screen back to what is depicted in Subfigure (a) in FIG. 13, for example. On the other hand, in a case where the user is in the standby state of Subfigure (a) in FIG. 14, the download operation section 50 acquires the precise insufficient storage space at that point. Subfigure (b) depicts a screen that is indicative of the lack of space and that is displayed in S156 in FIG. 12. The screen includes a lack-of-space display field 128 and a storage area operation start GUI 130. The lack-of-space display field 128 indicates the size of the insufficient storage space obtained by subtracting the free space of the data storage section 70 from the size of the data targeted for download. In the drawing, a lack of “55 GB” is indicated.

Here, in a case where the user operates the storage area operation start GUI 130, the storage area operation section 52 causes a screen for accepting storage area operations to be displayed. Subfigure (a) in FIG. 15 depicts a screen that is indicative of a list of candidate data to be deleted and that is displayed in S158 in FIG. 12. This screen includes a lack-of-space display field 140 and a deletion candidate list field 142. In an initial state, the size of the insufficient storage space displayed in the lack-of-space display field 140 is the same as that indicated on the screen of Subfigure (b) in FIG. 14. By comparing the displayed value with the size of each of the listed game applications, the user selects the games that can be deleted.

Because the number of games that can be displayed simultaneously in the deletion candidate list field 142 is limited, the list may be arranged to be scrolled. Alternatively, as indicated in the upper part of the deletion candidate list field 142, the order in which to display the list may be changed from multiple viewpoints. For example, the games may be sorted in the order of date and time at which they were last downloaded or last played, or in alphabetical order of their names, to make selection of data to be deleted more efficient.

The screen in Subfigure (b) depicts a state in which one game is selected. In this example, a check mark 144 indicates that the game titled “DDDD” is selected. In response to this selection operation, the storage area operation section 52 updates the lack-of-space display field 140. That is, the lack of space that will remain following deletion of the selected game is displayed. In the drawing, the game with a size of “17 GB” is selected, so that the lack of space is updated from “55 GB” to “38 GB.” In this manner, when the user is prompted to select the game targeted for deletion and the lack of space is thereby expected to be resolved, a request to finalize the deletion is accepted.

Subfigure (c) depicts the screen at that point. In this example, the lack-of-space display field 140 is caused to indicate that the lack of space will be resolved if the selected game is deleted, with a deletion start GUI 146 further displayed. When the target for deletion is a game application, an “Uninstall” button is displayed as the deletion start GUI 146 as depicted. Incidentally, in the drawing, the deletion start GUI 146 also indicates numerically that two games are being selected to be deleted. When the user operates the deletion start GUI 146, the storage area operation section 52 issues a deletion request. The issued request causes the content processing apparatus 12 to perform a deletion process.

When the deletion process is successful, the result of the process is returned to the information terminal 10 as indicated in FIG. 9. Subfigure (d) depicts a screen indicating that the deletion has been successful, the screen further including a process result display field 148 and a storage area operation end GUI 150. The user verifies the successful deletion by checking the process result display field 148, before operating the storage area operation end GUI 150. This closes the screen for storage area operations, resumes the download process that has been interrupted, and causes the display to transition to a screen indicative of the ongoing download, such as one in Subfigure (b) or (c) in FIG. 13.

FIG. 16 depicts another example of the screen displayed on the information terminal 10 in the case where a lack-of-space error has occurred during download. For this example, assumed is a case in which the user having performed the download operations on the screens depicted in FIG. 13 closes the screen for download operations for the moment, before being given an error notification. Subfigure (a) depicts a state in which a push notification of the error is made on the home screen that includes an error notification field 160 and a storage area operation start GUI 162.

The error notification field 160 indicates that an error has occurred during the download process and displays the contents of the error, together with information regarding the game targeted for the download. At this point, the user operates the error notification field 160, which displays a screen for download operations as depicted in Subfigure (b). In this example, an error contents display field 164 is provided on the download operation screen. The error contents display field 164 indicates an error detail display GUI 166 along with a description outlining the error. When the user operates the error detail display GUI 166, the details of the error, not depicted, are displayed.

Meanwhile, in a case where the user operates the storage area operation start GUI 162 on the screen in Subfigure (a), the screen for storage area operations such as one in FIG. 15 is displayed. The operations subsequent to the display may be similar to those explained above with reference to FIG. 15. It is to be noted that, in a case where the push notification such as one depicted in Subfigure (a) is followed by resolution of the error before any subsequent operation is carried out, any operation that may be performed in response to the push notification may be made invalid.

According to the present embodiment described above, the operations to download data from a server to a content processing apparatus are made possible from an apparatus other than that content processing apparatus. By use of an information terminal, for example, the user can start the download in an in-between time regardless of time and place while on the road. The user can then enjoy the downloaded content at a desired timing such as when coming home.

Also, the progress status of the download and the contents of an error are acquired via a management server and displayed in real time on the apparatus from which the download has been requested. This allows the user to surely verify whether the download is being performed or interrupted and, in the case of the interruption, to recognize the cause of the interruption at a desired timing. In the case where a lack of storage space has occurred as an error in the content processing apparatus, the apparatus from which the download has been requested is enabled to operate on the storage area of the content processing apparatus, i.e., to delete stored data therefrom.

The request of a download, verification of a lack of storage space, selection of stored data from a list, and deletion of the selected data are all made possible as a series of operations from the same apparatus. Consequently, the simple transmission of information via networks allows the user to determine how to handle an error that may occur and to easily resolve the error. Providing the means for handling error in this manner improves the possibility of a successful download even at remote locations. With the download operations carried out apart from the content processing apparatus in terms of both time and place, there will be fewer missed opportunities for obtaining the content that has provoked interest.

The present invention has been described above in conjunction with the embodiment. It is to be understood by those skilled in the art that suitable combinations of the constituent elements and of various processes of the embodiment described above as examples will lead to further variations of the present invention and that such variations also fall within the scope of this invention.

### INDUSTRIAL APPLICABILITY

As discussed above, the present invention can be used in conjunction with diverse information processing apparatuses including information terminals, mobile terminals, game consoles, content processing apparatuses, personal computers, and management servers, as well as in connection with systems that includes any one of these apparatuses.

### REFERENCE SIGNS LIST

1: Information processing system
10: Information terminal
12: Content processing apparatus
14: Management server
16: Content providing server
23: CPU
24: GPU
26: Main memory
48: Input information acquisition section
50: Download operation section
52: Storage area operation section
54: Error notification section
56: Download control section
58: Download request storage section
60: State management section
62: State information storage section
64: Storage area operation section
66: Error notification section
68: Data acquisition section
70: Data storage section
72: Storage area operation section
74: State providing section
76: State information storage section
78: Error notification section

1. An information terminal comprising:
a storage area operation section configured to acquire, from a management server via a network, information regarding a state of a storage area in an external information processing apparatus and cause the acquired information to be displayed; and
an input information acquisition section configured to accept a user operation to change the state of the storage area on a basis of the displayed information,
wherein the storage area operation section transmits contents of the user operation to the management server to achieve a state change of the storage area according to the user operation.

2. The information terminal according to claim 1, further comprising:
a download operation section configured to accept a user operation to download data from a data providing server to the information processing apparatus, and issue a download request in connection with the user operation to the management server,
wherein, if a lack-of-space error occurs in the storage area during execution of the download, the storage area operation section accepts a user operation to delete data stored in the storage area.

3. The information terminal according to claim 2, wherein, at a time at which the lack-of-space error occurs, the storage area operation section acquires, from the management server, information regarding the stored data in the storage area, displays the acquired information as a list of data candidates targeted for deletion, and accepts a user operation to select at least one of the listed candidates as the target for deletion.

4. The information terminal according to claim 2, wherein the download operation section acquires, from the management server, contents of an error having occurred during execution of the download, and displays the acquired error contents and a graphical user interface for handling the error.

5. The information terminal according to claim 4, wherein, at a time at which the lack-of-space error occurs in the storage area, the download operation section acquires, from the management server, a numerical value of a lacking storage space at that point and displays the acquired numerical value.

6. The information terminal according to claim 2, wherein, at a time at which the lack-of-space error occurs in the storage area, the download operation section causes a graphical user interface for starting an operation on the storage area to be displayed, and,
when the graphical user interface for starting an operation on the storage area is operated, the storage area operation section causes a storage area operation screen to be displayed.

7. The information terminal according to claim 2, wherein the download operation section acquires, from the management server, a progress status of the download for which the request has been issued, and displays the acquired download progress status.

8. The information terminal according to claim 2, further comprising:
an error notification section configured to acquire, from the management server, a push notification indicative of contents of the error having occurred during execution of the download for which the request has been issued by the download operation section, the error notification section further causing the acquired push notification to be displayed.

9. The information terminal according to claim 2, wherein the download operation section acquires, from the management server, information regarding the information processing apparatus that is able to be designated as a download destination, displays the acquired information, and thus accepts a user operation to select the information processing apparatus as the download destination.

10. A management server comprising:
a state management section configured to connect with an information processing apparatus via a network and collect information regarding a state of a storage area in the information processing apparatus; and
a storage area operation section configured to transmit, via the network, the information regarding the state to an information terminal different from the information processing apparatus and cause the information to be displayed, acquire contents of a user operation performed on the information terminal to change the state, and request the information processing apparatus for a process corresponding to the contents of the user operation, to achieve a state change of the storage area.

11. An information processing system comprising:
an information processing apparatus configured to perform information processing using data stored in a storage area thereof;
a management server configured to connect with the information processing apparatus via a network to acquire information regarding a state of the storage area and transmit the acquired information via the network to an information terminal different from the information processing apparatus; and
an information terminal configured to display the information regarding the state of the storage area, accept a user operation to change the state of the storage area on a basis of the displayed information, and transmit contents of the user operation to the management server, to achieve a state change of the storage area according to the user operation.

12. A download operation method comprising:
acquiring, from a management server via a network, information regarding a state of a storage area in an external information processing apparatus and causing the acquired information to be displayed;
accepting a user operation to change the state of the storage area on a basis of the displayed information; and
transmitting contents of the user operation to the management server to achieve a state change of the storage area according to the user operation.

13. A non-transitory, computer readable storage medium containing a computer program, which when executed by a computer, causes the computer to perform a download operation method by carrying out actions, comprising:
acquiring, from a management server via a network, information regarding a state of a storage area in an external information processing apparatus and causing the acquired information to be displayed;
accepting a user operation to change the state of the storage area on a basis of the displayed information; and
transmitting contents of the user operation to the management server to achieve a state change of the storage area according to the user operation.
